(19) United States
(12) Patent Application Publication
(10) Pub. No.: US 2015/0378133 A1
(43) Pub. Date: Dec. 31, 2015

(54) Imaging Device, Lens Unit, And Method For Manufacturing Imaging Device

(71) Applicant: KONICA MINOLTA, INC., Chiyoda-ku, Tokyo (JP)

(72) Inventors: Minoru KUWANA, Hachioji-shi, Tokyo (JP); Keiji ARAI, Hachioji-shi, Tokyo (JP)

(21) Appl. No.: 14/766,385

(22) PCT Filed: Feb. 12, 2014
(86) PCT No.: PCT/JP2014/053163

§ 371 Date: Aug. 6, 2015

(30) Foreign Application Priority Data
Feb. 14, 2013 (JP) 2013-026485
May 30, 2013 (JP) 2013-113636
Sep. 4, 2013 (JP) 2013-183015

(51) Int. Cl. G02B 13/00; G02B 7/02; H04N 5/225; G02B 3/00

(52) U.S. Cl. CPC G02B 13/0055; G02B 3/0075; G02B 7/028; G02B 7/025; G02B 3/0062; H04N 5/2254

(57) ABSTRACT

Imaging device includes a compound eye optical system equipped with an array lens formed by arranging multiple lenses as an array in which the lenses have mutually different light axes; a lens frame having a top surface part that covers the portion of a first surface on the object side of the compound eye optical system which excludes the lenses, and a side surface part that supports the top surface part; and a solid-state imaging element that converts a photographic subject imaged by the compound eye optical system into electrical signals. The side surface part of the lens frame is adhered to the solid-state imaging element or to a member that is affixed to the solid-state imaging element, and the portion of the first surface of the compound eye optical system which excludes the lenses is adhered to the top surface part of the lens frame.

### TECHNICAL FIELD

The present invention relates to an imaging device including a compound eye optical system in which multiple lenses are configured to face an object, a lens unit, and a method for manufacturing the imaging device.

### BACKGROUND ART

In recent years, thin type mobile terminals each equipped with an imaging device, represented by smart phones, tablet type personal computers, and the like, have spread rapidly. However, the imaging device mounted on such a thin type mobile terminal is required to be thin and compact while having high resolution. In order to respond to such a request, the overall length of imaging lenses has been shortened by the optical design, and precision in manufacturing has been improved so as to cope with an increase in error sensitivity due to the shortened overall length. However, with the conventional constitution in which an image is obtained with a combination of a single imaging lens and an imaging sensor, it is difficult to cope with further requests. Accordingly, an optical system which changes the concept of the conventional optical system will be expected.

On the other hand, in an optical system called a compound eye optical system, an imaging region of an imaging sensor is divided, multiple lenses are disposed for the respective divided imaging regions, and images obtained by the divided imaging regions are processed so as to output a final image. Such a compound eye optical system has been received a lot of attention in order to cope with a request to make an imaging device thinner (refer to PTL1).

### CITATION LIST

### Patent Literature

PTL1: Japanese Unexamined Patent Publication No. H10-145802

### PTL2: Japanese Unexamined Patent Publication No. 2007-295141

### SUMMARY OF INVENTION

### Technical Problem

Incidentally, in order to produce a large quantity of compound eye optical systems at low cost, it is desired to make a plurality of lenses integrally in a single body with plastics. However, in the case where a compound eye optical system is made of plastic, it has become clear that there is a possibility that image quality may lower. In concrete terms, in a convex lens, a lens back becomes long due to a refractive index change caused by a temperature change. As a result, an image forming position fluctuates to an extent being not negligible, which causes a possibility that an acquired image may be out of focus. On the other hand, an actuator to move a compound eye optical system in an optical axis direction may be disposed. However, disposing the actuator induces an increase in cost.

Then, the present inventor has considered a technique to cope with these problems by devising a supporting structure for a compound eye optical system. However, as shown in PTL2, with a technique to fix a compound eye optical system to a lens frame, it is difficult to eliminate those problems. Further, PTL2 is silent on fluctuation of an image forming position due to a refractive index change caused by a temperature change of lenses and a technique to eliminate such fluctuation.

The present invention has been achieved in view of the problems of the conventional techniques, and an object of the present invention is to provide an imaging device using a compound eye optical system which can be mass-produced at low cost and can suppress fluctuation of an image forming position, a lens unit, and a method for manufacturing the imaging device.

### Solution to Problem

An imaging device, comprising: a compound eye optical system equipped with an array lens in which multiple lenses are arranged in a form of an array such that each of the multiple lenses has an optical axis different from those of the other lenses and at least a part of the multiple lenses is made of plastic;

a lens frame which is made of plastic and includes a top surface portion to cover a portion, except the lenses, of an object-side first surface of the compound eye optical system and a side surface portion to support the top surface portion; and a solid state imaging sensor for converting an image of an object formed by the compound eye optical system into electric signals;

wherein the side surface portion of the lens frame is bonded to the solid state imaging sensor or to a member fixed to the solid state imaging sensor, and

a part, except the lenses, of the first surface of the compound eye optical system is bonded to the top surface portion of the lens frame.

According to the present invention, in the lenses of the compound eye optical system, in the case where a refractive index change is caused by a temperature change, expansion or contraction of the lens frame connected to the solid state imaging sensor caused by the same temperature change is used to suppress out of focus. Namely, a part, except the lenses, of the first surface of the compound eye optical system is bonded to the top surface portion of the lens frame. Accordingly, a position of the compound eye optical system in the optical axis direction relative to the solid state imaging sensor changes comparatively largely in accordance with expansion or contraction of the lens frame. Then, by using such a positional change, a change of an image forming position due to a refractive index change of the lenses can be reduced. With this, an in-focus image can be acquired irrespective of a temperature change.

A lens unit comprising:

a compound eye optical system equipped with an array lens in which multiple lenses are arranged in a form of an array such that each of the multiple lenses has an optical axis different from those of the other lenses and at least a part of the multiple lenses is made of plastic; and

a lens frame which is made of plastic and includes a top surface portion to cover a portion, except the lenses, of an object-side first surface of the compound eye optical system and a side surface portion to support the top surface portion;

wherein a part, except the lenses, of the first surface of the compound eye optical system is bonded to the top surface portion of the lens frame, and the side surface portion of the lens frame includes an end portion capable of being bonded to a solid state imaging sensor for converting an image of an object formed by the compound eye optical system into electric signals or to a member fixed to the solid state imaging sensor.

According to the present invention, a part, except the lenses, of the first surface of the compound eye optical system is bonded to the top surface portion of the lens frame. Accordingly, a position of the compound eye optical system in the optical axis direction relative to the solid state imaging sensor changes comparatively largely in accordance with expansion or contraction of the lens frame. Then, by using such a positional change, a change of an image forming position due to a refractive index change of the lenses can be reduced.

A method for manufacturing an imaging device which includes a compound eye optical system equipped with an array lens in which multiple lenses are arranged in a form of an array such that each of the multiple lenses has an optical axis different from those of the other lenses and at least a part of the multiple lenses is made of plastic; and a lens frame which is made of plastic and includes a side surface portion to surround an outer periphery of the compound eye optical system and a top surface portion to cover a part, except the lenses, of a first surface of the compound eye optical system;

the method for manufacturing an imaging device comprising:
providing a bonding agent onto the top surface portion of the lens frame;

bonding and securing the compound eye optical system to the lens frame; and

bonding and securing the side surface portion of the lens frame to a solid state imaging sensor or to a member fixed to the solid state imaging sensor.

According to the present invention, a part, except the lenses, of the first surface of the compound eye optical system is bonded and secured to the top surface portion of the lens frame, and the side surface portion of the lens frame is bonded and secured to the solid state imaging sensor or to a member fixed to the solid state imaging sensor. Accordingly, a position of the compound eye optical system in the optical axis direction relative to the solid state imaging sensor changes comparatively largely in accordance with expansion or contraction of the lens frame. Then, by using such a positional change, a change of an image forming position due to a refractive index change of the lenses can be reduced.

A method for manufacturing an imaging device which includes a compound eye optical system equipped with an array lens in which multiple lenses are arranged in a form of an array such that each of the multiple lenses has an optical axis different from those of the other lenses and at least a part of the multiple lenses is made of plastic; and a lens frame which is made of plastic and includes a side surface portion to surround an outer periphery of the compound eye optical system and a top surface portion to cover a part, except the lenses, of a first surface of the compound eye optical system;

the method for manufacturing an imaging device comprising:

providing a bonding agent onto a part, except the lenses, of a first surface of the compound eye optical system;

bonding and securing the lens frame to the compound eye optical system; and

bonding and securing the side surface portion of the lens frame to a solid state imaging sensor or to a member fixed to the solid state imaging sensor.

According to the present invention, a part, except the lenses, of the first surface of the compound eye optical system is bonded and secured to the top surface portion of the lens frame, and the side surface portion of the lens frame is bonded and secured to the solid state imaging sensor or to a member fixed to the solid state imaging sensor. Accordingly, a position of the compound eye optical system in the optical axis direction relative to the solid state imaging sensor changes comparatively largely in accordance with expansion or contraction of the lens frame. Then, by using such a positional change, a change of an image forming position due to a refractive index change of the lenses can be reduced.

### Advantageous Effects of Invention

According to the present invention, it becomes possible to provide an imaging device using a compound eye optical system which can be mass-produced at low cost and can suppress fluctuation of an image forming position, a lens unit, and a method for manufacturing the imaging device.

### BRIEF DESCRIPTION OF DRAWINGS

FIG. 1 is an illustration showing schematically an imaging device in relation to an embodiment of the present example.

FIG. 2 is cross sectional view of an imaging unit LU.

FIG. 3 is a perspective view showing a first array lens LA1.

FIG. 4 is a cross sectional view similar to FIG. 2 and exaggeratedly shows deformation of the imaging device when a temperature change arises.

FIG. 5 is a cross sectional view similar to FIG. 2 and shows an imaging unit according to another embodiment.

FIG. 6 is a cross sectional view similar to FIG. 2 and shows an imaging unit according to another embodiment.

FIG. 7(a) is a cross sectional view similar to FIG. 2 and shows an imaging unit according to another embodiment, and FIG. 7(b) is a cross sectional view similar to FIG. 4.

FIGS. 8(a) to 8(c) each is an illustration showing a state where a coating position of a second bonding agent BD2 is changed.

FIG. 9 is a cross sectional view similar to FIG. 2 and shows a modified example of the present embodiment.

FIGS. 10(a) and 10(b) each is an illustration showing an example of a pattern in which a first bonding agent BD1 is coated on an image side surface of a first array lens LA1.

FIGS. 11(a) to 11(c) each is an illustration showing a process of molding a first array lens LA1.

FIG. 12 is a cross sectional view similar to FIG. 2 and shows an imaging unit according to another embodiment.

FIGS. 13(a) to 13(c) each is an illustration showing a process of molding a first array lens WL1.

FIG. 14 is an illustration showing a portion indicted with an arrow head XVI in the array lenses WL1 and WL2 shown in FIG. 12 by expanding the portion.

FIG. 15 is a cross sectional view similar to FIG. 12 and exaggeratedly shows deformation of the imaging device when a temperature change arises, in relation to the present embodiment.

FIG. 16 is a perspective view showing a model of a lens frame used in the present simulation.

FIG. 17(a) is a diagram in which an axis of ordinate represents an expanding ratio at a position P1 and an axis of abscissa represents a value of A/H. FIG. 17(b) is a diagram in which an axis of ordinate represents an expanding ratio at a position P2 and an axis of abscissa represents a value of A/H.

FIG. 18 is a cross sectional view of an ommatidium optical system of Example 1.

FIG. 19 is a cross sectional view of an ommatidium optical system of Example 2.

FIG. 20 is a cross sectional view of an ommatidium optical system of Example 3.

### DESCRIPTION OF EMBODIMENTS

Hereinafter, description is given to a compound eye optical system and an imaging device using it according to the present invention. The compound eye optical system is an optical system in which multiple lens systems (ommatidium optical systems) are arranged in a form of an array, and the compound eye optical system is usually classified into a super resolution type in which each of the multiple lens systems is configure to image the same view field and a view field division type in which each of the multiple lens systems is configured to image a respective different view field. As the compound eye optical system according to the present invention, any one of the two types may be used. However, in this embodiment, description is given to the super resolution type in which multiple lens systems are arranged to face in the same direction and have respective minute parallaxes and multiple images obtained by the multiple lens systems are subjected to super resolution processing so as to output a synthesized image on a single sheet with resolution higher than that of each of the multiple images.

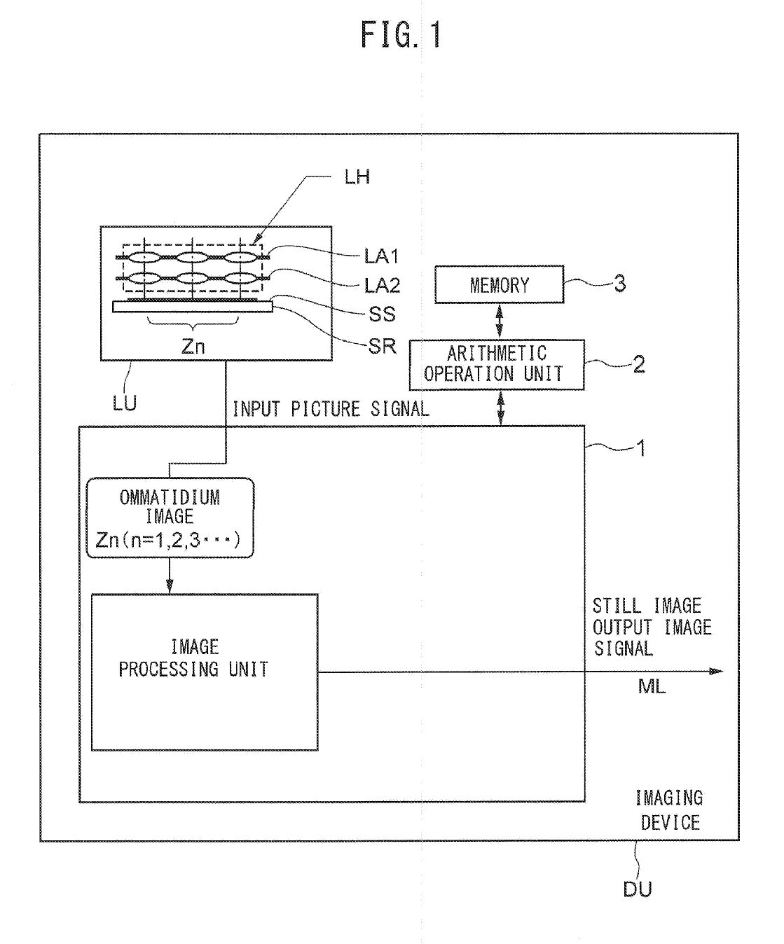

FIG. 1 shows schematically an imaging device according to the present embodiment. As shown in FIG. 1, an imaging device DU includes an imaging unit LU, an image processing unit 1, an arithmetic operation unit 2, and a memory 3. The imaging unit LU includes a single imaging sensor SR and a compound eye optical system LH composed of multiple optical systems which have respective minute parallaxes and form multiple images onto the imaging sensor. As the imaging sensor SR, a solid state imaging sensor, such as a CCD type imaging sensor and a CMOS type imaging sensor each of which includes multiple pixels, may be used. The compound eye optical system LH is disposed so as to form optical images of an object on a light receiving section SS being a photoelectric converting section of the imaging sensor SR, and the optical images formed by the compound eye optical system LH are converted into electric signals by the imaging sensor SR. An image synthesizing section 1a in the image processing unit 1 is configured to perform image processing based on electrical signals corresponding to multiple images sent from the imaging sensor SR so as to obtain image data in the form of a single sheet with higher resolution from images in the form of multiple sheets.

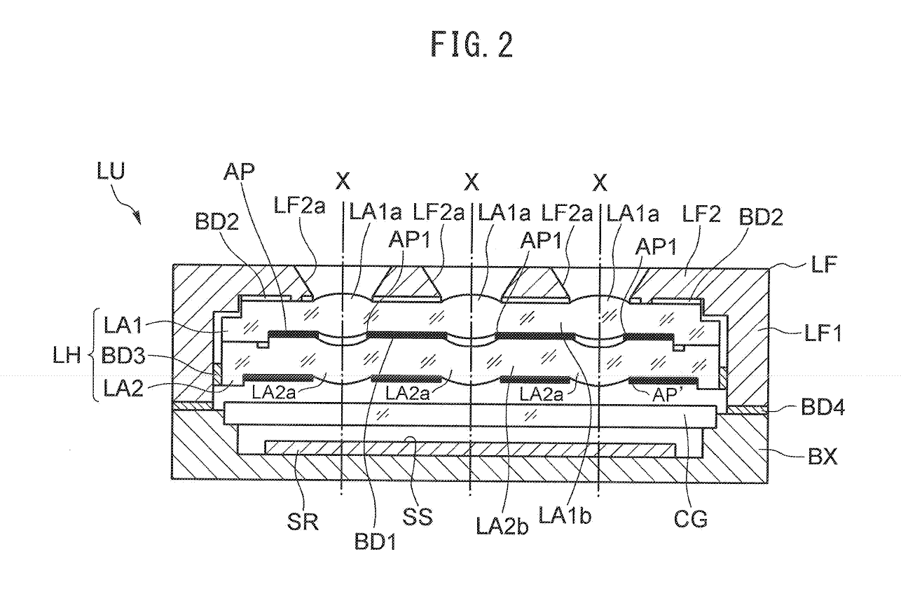

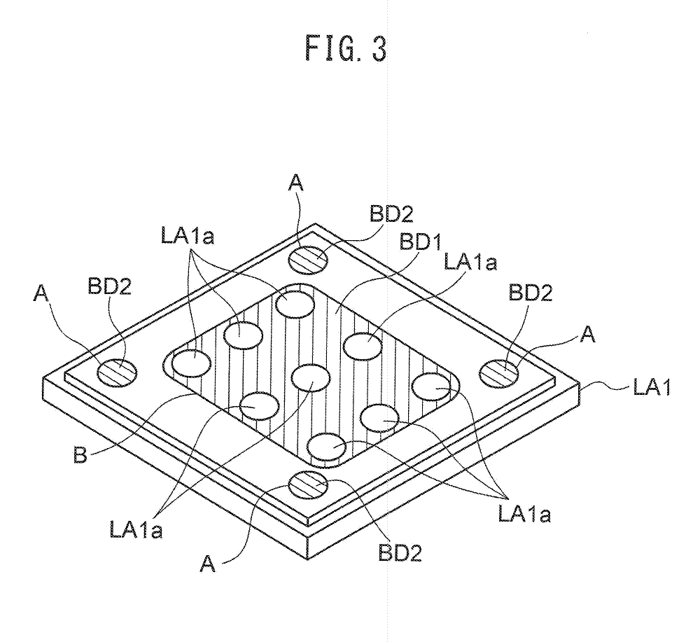

FIG. 2 is a cross sectional view of the imaging unit LU. In FIG. 2, a top side corresponds to an object side. The compound eye optical system LH includes a first array lens LA1 and a second array lens LA2. In the first array lens LA1, multiple object side lenses LA1a (here, nine lenses arranged in a form of three rows and three columns) and flange portions LA1b each configured to connect between two lenses LA1a are formed integrally. In the second array lens LA2, multiple image side lenses LA2a (here, nine lenses arranged in a form of three rows and three columns) and flange portions LA2b each configured to connect between two lenses LA2a are formed integrally. The first array lens LA1 and the second array lens LA2 are made from a resin material for optics, such as polycarbonate and an acrylic resin by injection molding. The optical axis X of one of the object side lenses LA1a is made to coincide with the optical axis X of a corresponding one of the image side lenses LA2a. Thus, each of the multiple lenses is superimposed in the optical axis direction so as to form an image, whereby optical properties, such as aberration correction can be enhanced. FIG. 3 shows a perspective view of the first array lens LA1.

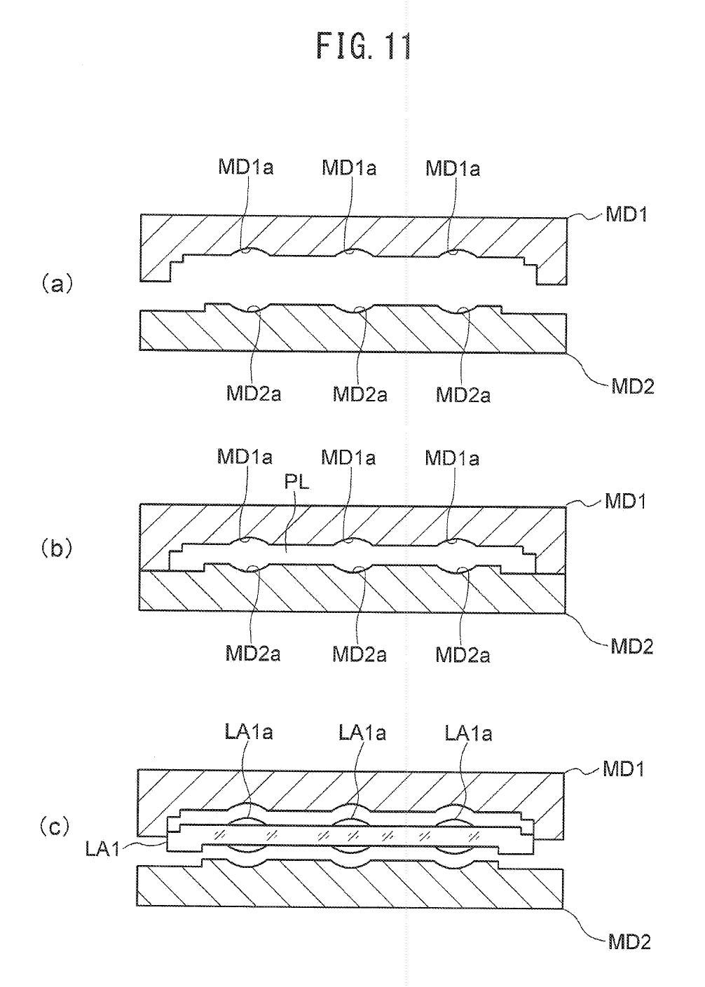

FIG. 11 is an illustration showing a process of molding the first array lens LA1. A first molding die MD1 and a second molding die MD2 have multiple optical surface transferring surfaces MD1a and MD2a respectively on respective surfaces which face each other. As shown in FIG. 11(a), the optical surface transferring surfaces MD1a and MD2a are arranged so as to face each other, and as shown in FIG. 11(b), the first molding die MD1 and the second molding die MD2 are clamped to form one mold. Subsequently, a resin material PL is filled up in a cavity in the inside of the mold through a not-shown gate. In this state, the resin material PL is allowed to harden.

After the hardening of the resin material PL, as shown in FIG. 11(c), the first molding die MD1 and the second molding die MD2 are separated from each other so as to open the mold, whereby the first array lens LA1 is molded. In the first array lens LA1, the respective object side surfaces of the object side lenses LA1a are formed by the optical surface transferring surfaces MD1a, and the respective image side surfaces of the object side lenses LA1a are formed by the optical surface transferring surfaces MD2a. Through the same process, the second array lens LA2 can be molded. In this way, array lenses can be molded at low cost with high precision by using molding dies. In the case where multiple array lenses are used, a part of them is made to include an array lens molded from plastic, and the remaining part of them is made to include an array lens composed of a substrate and lens portions.

In FIG. 2, on a portion between the first array lens LA1 and the second array lens LA2, a light shielding member AP composed of a metal plate or a resin plate is arranged. In the light shielding member AP, multiple openings AP1 (here, nine openings arranged in a form of three rows and three columns) each having a center at its optical axis X, are formed. On a portion between the first array lens LA1 and the light shielding member AP and on a portion between the second array lens LA2 and the light shielding member AP, a first bonding agent BD1 is coated. It is preferable that the coating position of the first bonding agent BD1 is positioned on a region B shown by hatching in FIG. 3. The bonding between the first array lens LA1 and the second array lens LA2 increases the rigidity of the compound eye optical system LH. Accordingly, even when a lens frame LF deforms with expansion or contraction, it becomes possible to suppress the compound eye optical system LH from deforming without following the deformation of the lens frame LF. Further, the rigidity of the compound eye optical system LH is increased by the light shielding member AP. Accordingly, even when the lens frame LF deforms with expansion or contraction, the compound eye optical system LH can be suppressed from deforming without following the deformation of the lens frame LF. Moreover, a light shielding member AP′ with the same shape is bonded to the image side surface of the second array lens LA2. However, instead of the light shielding member, a black material, such as ink may be coated.

On the other hand, the lens frame LF made from resin materials, such as black polycarbonate includes a side surface portion LF1 which is shaped in a rectangular frame and arranged to surround the periphery of the compound eye optical system LH and a top surface portion LF2 which is made to extend and reside from the top end of the side surface portion LF1 to the inner side. On the top surface portion LF2, multiple openings LF2a (here, nine openings arranged in a form of three rows and three columns) each having a center at its optical axis X, are formed. In a portion between the side surface portion LF1 of the lens frame LF and the outer peripheral surface of the compound eye optical system LH, a gap is formed. Such a gap is made in a value with which the lens frame LF and the compound eye optical system LH are made not to come in contact with each other even when a temperature change arises from a room temperature to the highest temperature.

On a portion between the vicinity of a corner (a region A positioned on the inside than the outer periphery and indicated by hatching in FIG. 3) of the object side surface in the first array lens LA1 of the compound eye optical system LH and the image side surface of the top surface portion LF2 of the lens frame LF, a second bonding agent BD2 is coated, whereby the compound eye optical system LH and the lens frame LF are bonded locally to each other. The second bonding agent (main bonding agent) BD2 may be a UV hardenable bonding agent. However, it is preferable that the second bonding agent BD2 is a heat hardenable bonding agent with Young's modulus, after hardening, of 10 MPa or more and 500 MPa or less and a heat hardenable bonding agent capable of hardening at a temperature of 60° C. or less.

In the case where the second bonding agent BD2 has a Young's modulus, after hardening, of 10 MPa or more, an adhesion thickness is stabilized, and a sufficient performance can be acquired. Further, in the case where the second bonding agent BD2 has a Young's modulus, after hardening, of 500 MPa or less, sufficient flexibility can be acquired, and excellent impact resistance can be acquired. Furthermore, if an energy hardenable bonding agent is used, high adhesion strength can be obtained within a short time. However, since the bonding agent BD2 is used within the lens frame LF, there may be a case where light is difficult to arrive from the outside. In such a case, it is preferable to use a heat hardenable bonding agent.

In the case where the bonding agent BD2 has a characteristic capable of hardening at a comparatively low temperature of 60° C. or less, it becomes unnecessary to hold the compound eye optical system LH and the lens frame LF in a high temperature environment higher than 60° C. at the time of bonding. Accordingly, it becomes possible to avoid large deformation which may take place on the compound eye optical system LH and the lens frame LF at the time of returning them to room temperature after bonding them at a high temperature environment higher than 60° C.

Examples usable as the bonding agent BD2 are shown hereafter. For example, as the heat hardenable elastic bonding agent, silicone bonding agents are used widely because of a low Young's modulus after hardening and low cost. However, since siloxane gas may be generated at the time of heat hardening, it is preferable to use urethane bonding agents in order to avoid occurrence of poor bonding. Examples of the urethane bonding agents include SPK-86 (product name) manufactured by Yokohama Rubber Co., Ltd and 1539 (product name) manufactured by Three Bond Co., Ltd. On the other hand, as ultraviolet hardenable bonding agents, 3016H (product name) manufactured by Three Bond Co., Ltd., may be preferable.

Furthermore, a third bonding agent BD3 may be provided between a lower end outer peripheral portion of the second array lens LA2 of the compound eye optical system LH and the side surface portion LF1 of the lens frame LF so as to bond the both portions. The third bonding agent BD3 has a function to hold the outer peripheral portion of the compound eye optical system LH supplementarily. However, since the modulus of elasticity of the third bonding agent BD3 after hardening is smaller than that of the second bonding agent BD2, the third bonding agent BD3 is not likely to hinder deformation of the lens frame LF.

The lower end of the side surface portion LF1 of the lens frame LF is fixed to a lower casing BX with a fourth bonding agent BD4. In the case where the modulus of elasticity of the fourth bonding agent BD4 after hardening is smaller than that of the second bonding agent BD2, the lens frame LF and the lower casing BX are connected rigidly so as to be constituted to be difficult to separate from each other. Accordingly, the deformation of the lens frame LF becomes effective. On the other hand, in the case where the modulus of elasticity of the fourth bonding agent BD4 after hardening is larger than that of the second bonding agent BD2, the lens frame LF and the lower casing BX are connected gently, and the deformation of the bonding agent BD4 becomes effective. The lower casing BX holds an imaging sensor SR on its bottom surface and has a function to hold a cover glass CG disposed between the imaging sensor SR and the compound eye optical system LH.

At the time of assembling the compound eye optical system LH into the lens frame LF, in the case where the second bonding agent BD2 is a heat hardenable bonding agent, the assembling is performed as follows. First, the molded first array lens LA1 and second array lens LA2 are bonded to each other via the light shielding member AP disposed between them so as to form the compound eye optical system LH. Subsequently, the image side surface of the compound eye optical system LH is arranged so as to face downward. For the lens frame LF arranged such that its top and bottom are reversed, the second bonding agent BD2 is coated on the top surface portion LF2 of the lens frame LF at portions corresponding to the vicinity of corners (the regions A shown in FIG. 3 by hatching) of the object side surface of the compound eye optical system LH. Thereafter, the both members are brought in contact with each other and heated, whereby bonding is achieved. Subsequently, the third bonding agent BD3 is given and hardened between the outer periphery of the compound eye optical system LH and the inner periphery of the lens frame LF. Further, the lens frame LF is connected with the fourth bonding agent BD4 to the lower casing BX (or the imaging sensor SR) which supports the imaging sensor SR and the cover glass CG.

On the other hand, in the case where each of the first bonding agent BD1 and the second bonding agent BD2 is a UV hardenable bonding agent, the compound eye optical system LH is assembled into the lens frame LF in the following ways. First, the image side surface of the molded first array lens LA1 is arranged so as to face downward. For the lens frame LF arranged such that its top and bottom are reversed, the second bonding agent BD2 is coated on the top surface portion LF2 of the lens frame LF at portions corresponding to the vicinity of corners (the regions A shown in FIG. 3 by hatching) of the object side surface of the first array lens LA1. Thereafter, the both members are brought in contact with each other and bonded to each other by being irradiated with UV light from the transparent first array lens LA1 side. Subsequently, the light shielding member AP is disposed on the first array lens LA1, the first bonding agent BD1 is coated, and then, the second array lens LA2 is superimposed on them. They are bonded to each other by being irradiated with UV light from the transparent second array lens LA2 side. Thereafter, the above processes are performed similarly.

Alternatively, the assembling may be achieved in the following ways. A bonding agent is provided to a part of the first surface (an object side surface) on the object side except the lenses on the compound eye optical system LH, and the lens frame LF is bonded and fixed to the compound eye optical system LH. Further, the side surface portion LF1 of the lens frame LF is bonded and fixed to the lower casing BX (or the imaging sensor SR) which is a member fixed to the imaging sensor SR.

Description is given to operation in the present embodiment. In FIG. 1, an object is divided by lenses of the compound eye optical system LH so as to form multiple images (ommatidium images) Zn on the imaging surface SS of the imaging sensor SR, the multiple images are converted into respective electrical signals, and the electrical signals are input to an image synthesizing section 1a. The image synthesizing section 1a synthesizes an ommatidium synthetic image ML in the form of a single sheet corresponding to image data in the form of a single sheet with higher resolution from images in the form of multiple sheets and outputs it. At this time, an image correcting section 1b performs inversion processing, distortion processing, shading processing, and joining processing. Further, distortion correction may also be performed if needed.

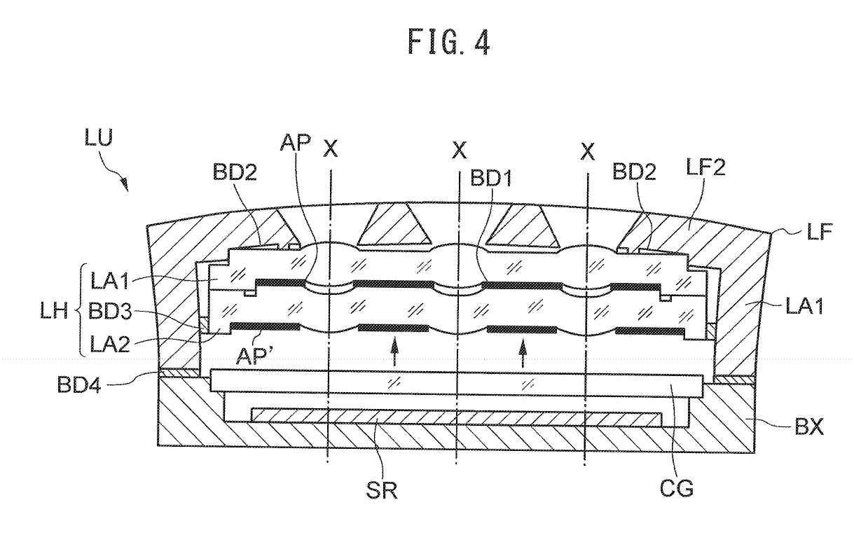

FIG. 4 is a cross sectional view similar to FIG. 2 and exaggeratedly shows deformation of the imaging device when a temperature change arises. For example, when environmental temperature rises, in lenses LA1a and LA2a of the compound eye optical system LH made of plastic, in the case of a convex lens, an image forming position generally goes far due to occurrence of a refractive index change by a temperature rise. In the case of a concave lens, a change of the image forming position is reverse to the above. However, since the total power of the respective optical systems is positive, the image forming position is made to go far in the total view. On the other hand, if the lens frame LF is subjected to the same temperature rise, the top surface portion LF2 deforms so as to become a convex form toward the upper portion (object side). Accordingly, its undersurface is raised upward. Here, since a part of the object side surface of the compound eye optical system LH is bonded to the undersurface of the top surface portion LF2, the compound eye optical system LH comparatively greatly moves toward a side made to separate from the imaging sensor SR along the optical axis in response to the deformation of the lens frame LF. Accordingly, the change of the image forming position due to the refractive index change of the lenses LA1a and LA2a is cancelled by the above movement, whereby the change can be reduced. Therefore, an in-focus image can be acquired irrespective of a temperature change. In the case where a temperature lowers, the situation is reverse to the above. That is, the image forming position of the lenses is made to come near, and the lens frame LF contracts, whereby the change of the image forming position can be reduced.

At this time, in the case where the hardness of the second bonding agent BD2 after hardening is comparatively high, after the hardening, even on the condition of room temperature, there is a fear that the top surface portion LF2 of the lens frame LF may deform in the form of a shallow dome and the array lenses LA1 and LA2 are made to curve due to the deformation. With this, variation in the focus position of the lenses LA1a and LA2a may arise. On the other hand, in the case where the Young's modulus of the second bonding agent BD2 after hardening is 10 MPa or more and 500 MPa or less, it turned out that deformation of the lens frame LF can be suppressed effectively. Further, it is effective also for shock resistance.

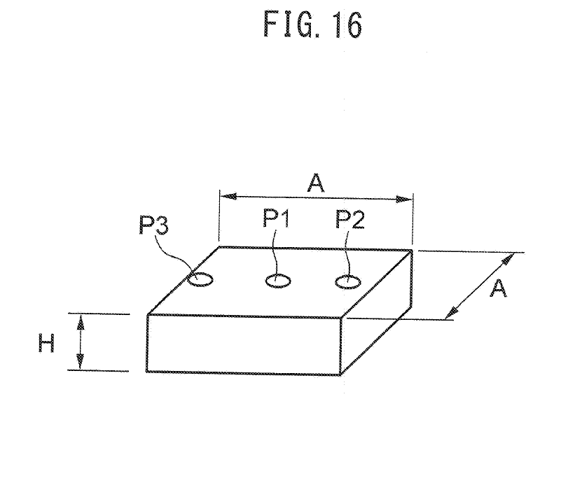

The present inventor performed simulation with regard to a temperature rise and a change of the lens frame. Hereinafter, description is given to the simulation result performed in the present invention. FIG. 16 is a perspective view showing a model of the lens frame used in this simulation. Here, the top surface portion of the lens frame was shaped into a square of A (mm)×A (mm), and the height of the lens frame was set to H (mm). In the case where the top surface portion of the lens frame was shaped into a rectangle of B (mm)×C (mm), the top surface portion was supposed to be approximated by A=(B+C)/2.

In this simulation, “an expanding ratio” was obtained for each of various specifications. The “expanding ratio” means a ratio of an amount of a position change of each portion (a central portion P1 of the top surface portion, a peripheral portion P2 of the top surface portion, a most peripheral portion P3 of the top surface portion as shown in FIG. 16) of the lens frame in the case where a temperature change (+30° C.) arises. In concrete terms, in the case where a temperature change (+30° C.) arises, the side surface portion of the lens frame extends, and also the central portion of the top surface portion deforms so as to expand. Accordingly, in an amount of a position change in a height direction based on the linear expansion coefficient of the material of the lens frame, that is, in a height change •1 at P3 and a height change •2 at each of P1 and P2, a ratio of •2/•1 is made to an expanding ratio. In the case where three kinds (t=0.4, 0.55, and 0.7 mm) of the thickness t of the lens frame were selected and the value of each of A and H was changed for each of the three kinds of the thickness t, the calculated expanding ratio at each of the positions P1 and P2 is shown in Table 1.

TABLE 1

| | | t = 0.55 | | | t = 0.4 | | t = 0.7 | |
|---|---|---|---|---|---|---|---|---|
| THICKNESS(mm) | | | EXPANDING | EXPANDING | EXPANDING | EXPANDING | EXPANDING | EXPANDING |
| LENGTH A | HEIGHT H(mm) | A/H | RATIO(P1) | RATIO(P2) | RATIO(P1) | RATIO(P2) | RATIO(P1) | RATIO(P2) |
| 14 | 2.8 | 5 | 11 | 4.1 | 10.9 | 4.7 | 8.4 | 2.9 |
| 14 | 2 | 7 | 19.5 | 6.9 | — | — | — | — |
| 14 | 5.6 | 2.5 | 2.5 | 1.5 | — | — | — | — |
| 28 | 2.8 | 10 | 55.1 | 14.5 | 42.7 | 8.2 | 49.8 | 12.8 |
| 9 | 2.8 | 3.2 | 3.8 | 2.2 | — | — | — | — |
| 4.2 | 2.8 | 1.5 | 1.3 | 1.2 | 1.3 | 1.1 | 1.3 | 1.2 |
| 4.2 | 2 | 2.1 | 2.1 | 1.4 | — | — | — | — |
| 28 | 5.6 | 5 | 8.2 | 2.7 | — | — | — | — |

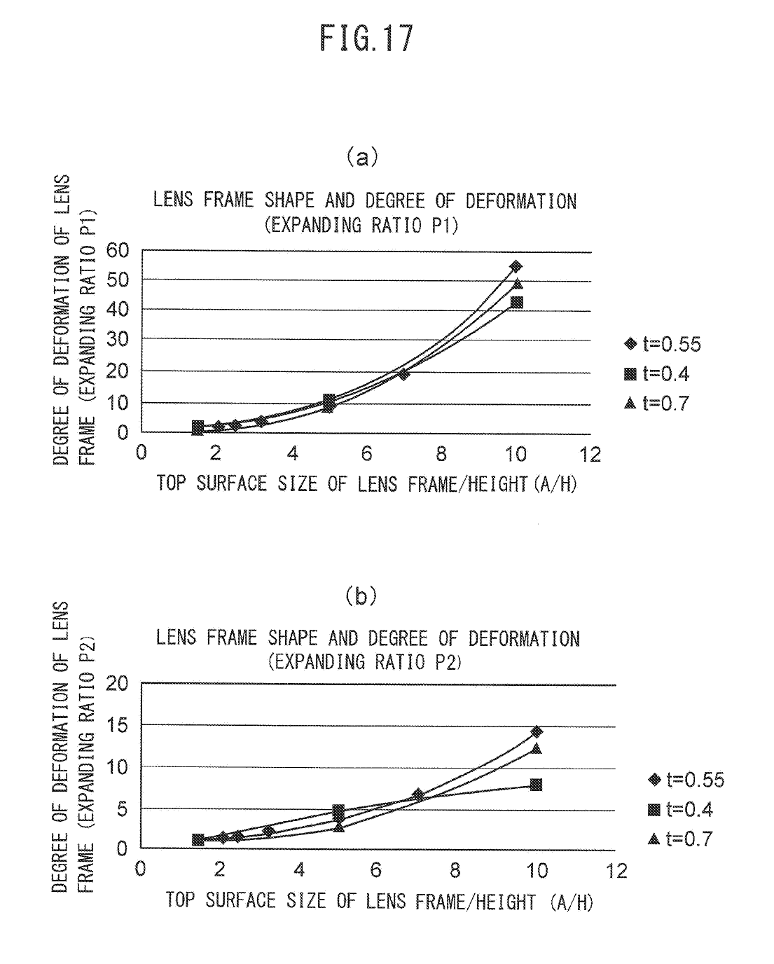

FIG. 17(a) is a diagram in which an axis of ordinate represents an expanding ratio at the position P1 and an axis of abscissa represents a value of A/H. FIG. 17(b) is a diagram in which an axis of ordinate represents an expanding ratio at the position P2 and an axis of abscissa represents a value of A/H. As a result of comparison between the respective expanding ratios of the positions P1 and P2, it turns out that since the central portion of the top surface portion deforms so as to expand in accordance with a temperature rise, there is a tendency that the central portion of the top surface portion tends to rise (P1>P2) than the peripheral portion of the top surface portion.

Further, as is evident from FIGS. 17(a) and 17(b), it turns out that there is a correlation between the expanding ratio and the value of A/H regardless of the thickness. Here, when consideration is given to a preferable range of A/H, if the value of A/H becomes less than 2, since the expanding ratio becomes almost constant, there is no meaning in making the value of A/H smaller. On the other hand, there is no restriction for the upper limit of A/H from the view of the expanding ratio. However, on the condition of A=14 mm and H=2.8 mm in Table 1, it has been already known from the examination that sixteen lens ommatidiums can be arranged in the form of 4×4=16. Accordingly, on the assumption of A=28 mm, it is supposed that the number of lens portions becomes sixty-four (64) in total in the form of eight rows and eight columns, which is too many for the number of lenses as a compound eye optical system for an imaging device. Therefore, it is preferable that the value of A/H=10 is made to the upper limit. Consequently, t is preferable to satisfy the following expression.

2·A/H·10 (1)

A: Size of one side of the top surface portion of the lens frame (mm)
H: Height of the lens frame (mm)

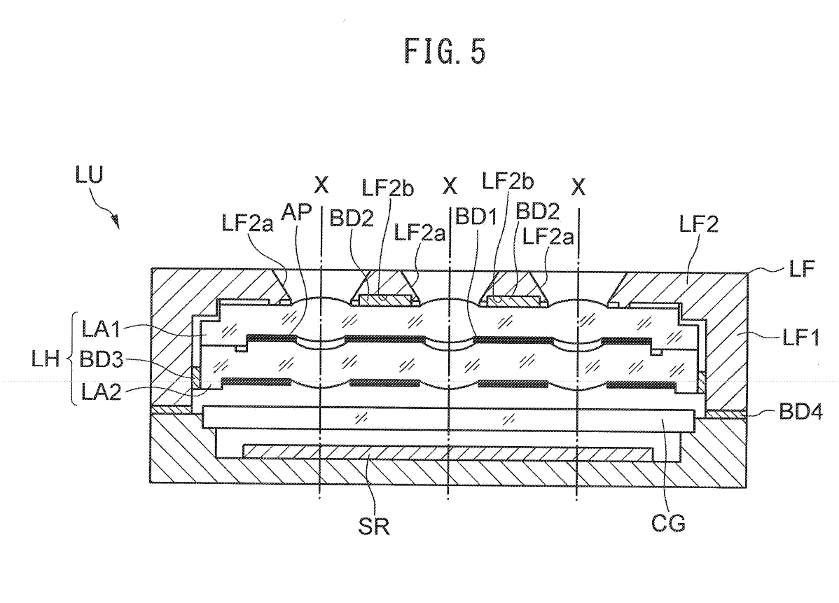

FIG. 5 is a cross sectional view similar to FIG. 2 and shows an imaging unit according to another embodiment. In the present embodiment, on the image side surface of the top surface portion LF2 of the lens frame LF, a concave portion (receptacle for a bonding agent) LF2b is disposed between lenses which neighbor on each other in a direction perpendicular to the optical axis, and the compound eye optical system LH and the lens frame LF are bonded with each other via the second bonding agent BD2 provided in the inside of the concave portion. With this, as compared with the above embodiment, the compound eye optical system LH can be moved more greatly from the imaging sensor SR. The constitutions other than the above are the same as those in the above-mentioned embodiment.

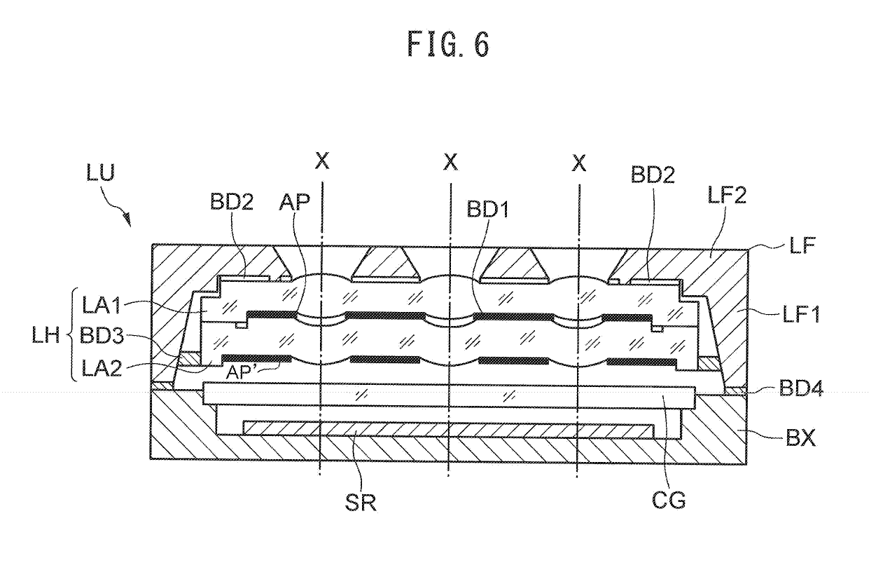

FIG. 6 is a cross sectional view similar to FIG. 2 and shows an imaging unit according to another embodiment. In the present embodiment, the cross sectional shape of the side surface portion LF1 of the lens frame LF is shaped in a taper such that its thickness is thicker on the top surface portion LF2 side and thinner on the imaging sensor SR side. With this, as compared with the above embodiments, the compound eye optical system LH can be moved more greatly from the imaging sensor SR. The cross sectional shape of the side surface portion LF1 should not be limited to the taper, and may be shaped in a stepped form in which its thickness becomes thinner as a position of the thickness of the side surface portion LF1 moves downward. The constitutions other than the above are the same as those in the above-mentioned embodiments.

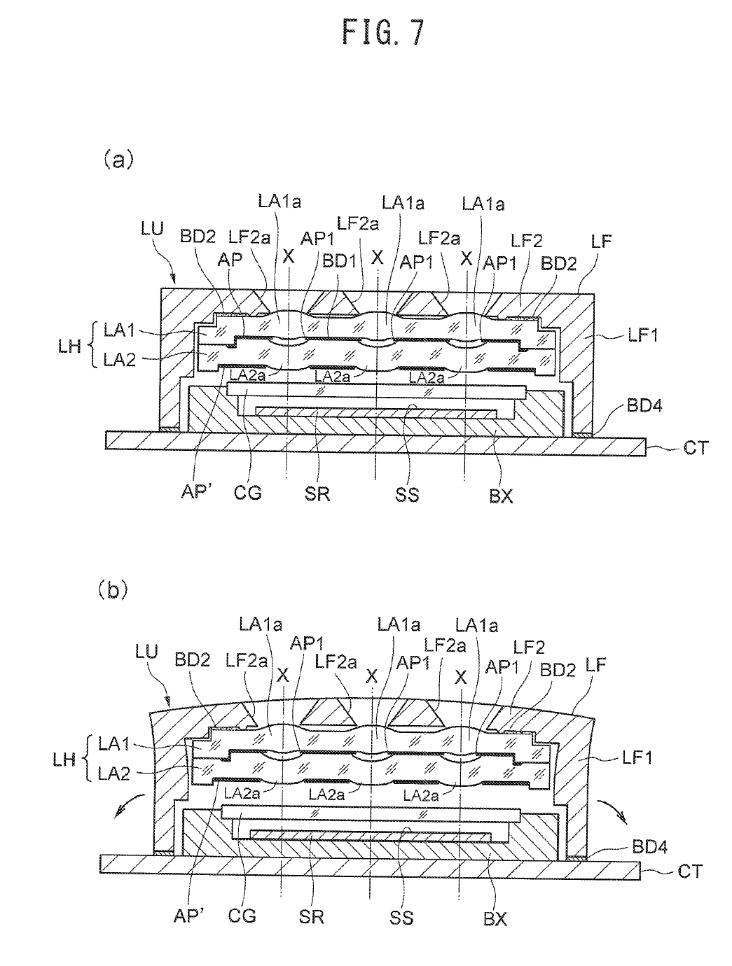

Each of FIGS. 7(a) and 7(b) is a cross sectional view similar to FIG. 2 and shows an imaging unit according to another embodiment. In the present embodiment, the lower casing BX which holds the solid state imaging sensor SR is held on the substrate CT. Further, the top surface portion LF2 of the lens frame LF is widened to exceed the lower casing BX up to the outside, and the lower end of the side surface portion LF1 is bonded to the top surface of the substrate CT with a fourth bonding agent BD4. The modulus of elasticity of the fourth bonding agent BD4 (a subsidiary bonding agent) after hardening is made lower than that of the second bonding agent BD2 which bonds the top surface portion LF2 of the lens frame LF 2 to the first array lens LA1. The fourth bonding agent BD4 has a modulus of elasticity of 10 to 4000 MPa, and examples of it include No. 5300T2 manufactured by Kyoritsu Chemistry & Co., Ltd. The side surface of the compound eye optical system LH is not bonded to the lens frame LF. The constitutions other than the above are the same as those in the above-mentioned embodiments.

Furthermore, according to the present embodiment, since the side surface portion LF1 of the lens frame LF is bonded directly to the substrate CT which holds the solid state imaging sensor SR, the size of the top surface portion LF2 can be made larger than the solid state image pickup device SR. Accordingly, an amount of deformation of the top surface portion LF2 at the time of a temperature change is made to increase, whereby an amount of displacement (positional change) of the compound eye optical system LH in the optical axis direction can be secured.

In particular, the material of the substrate CT is generally a glass epoxy resin which has a rigidity higher than that of the material of the lens frame LF. However, since the thickness of the substrate CT is comparatively thin, when temperature changes, the substrate CT itself deforms. Accordingly, there is a possibility that an ideal deformation of the lens frame LF may be obstructed. In this way, since the lower end of the side surface portion LF1 is bonded to the top surface of substrate CT, the side surface portion LF1 is extended. Accordingly, the influence of the deformation of the substrate CT can be suppressed.

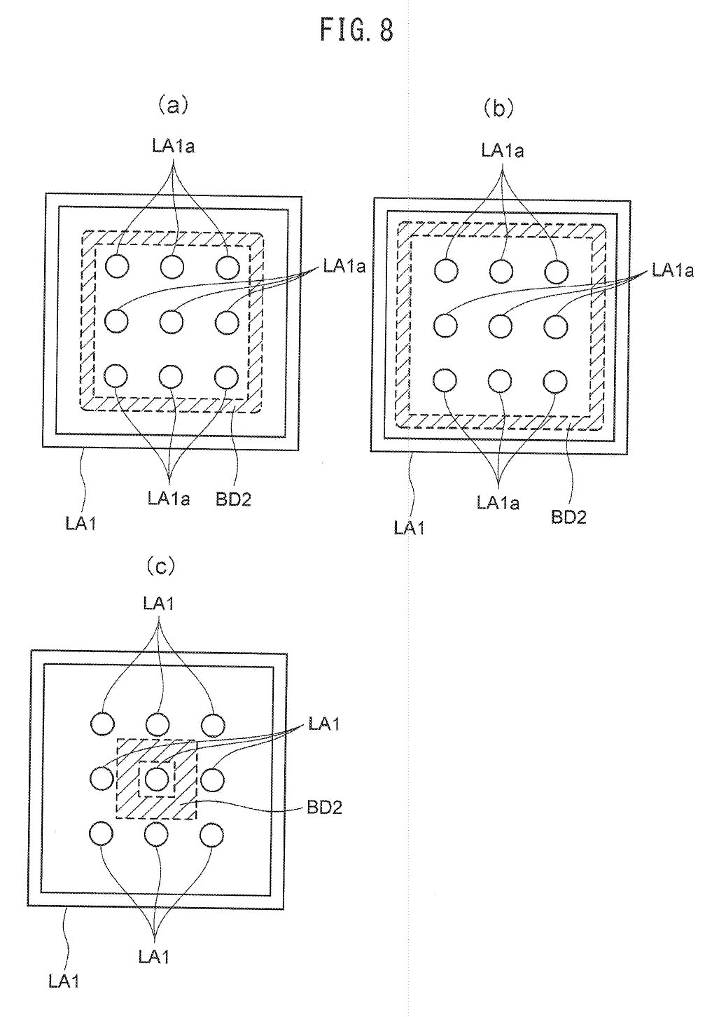

With regard to the coating position of the second bonding agent BD2 which bonds the top surface portion LF2 of the lens frame LF to the first array lens LA1, as shown in FIG. 8, in the case where the coating position is selected at any one of a position located far from the outer periphery (FIG. 8(a)) and a position located near to the outer periphery (FIG. 8(b)), an amount of change of the top surface portion LF2 at the time of a temperature change changes depending on the selected position. Accordingly, an amount of displacement of the compound eye optical system LH in the optical axis direction can be adjusted. Here, as shown in FIG. 7(b), at the time of a temperature change, the top surface portion LF2 of the lens frame LF deforms such that the central portion of the top surface portion LF2 becomes the highest. With the utilization of such deformation, the bonding position between the object side surface of the compound eye optical system LH and the top surface portion LF2 of the lens frame LF is designed so as to have a certain amount of width. Then, at the time of bonding the object side surface of the compound eye optical system LH to the top surface portion LF2 of the lens frame LF, the bonding position is changed in the direction perpendicular to the optical axis, whereby an amount of movement of the compound eye optical system LH in the optical axis direction at the time of an environmental temperature change can be adjusted. In concrete terms, in the case where an amount of correction of the compound eye optical system LH at the time of an environmental temperature change is insufficient, bonding may be made at a position located far from the outer periphery as shown in FIG. 8(a). On the other hand, in the case where an amount of correction of the compound eye optical system LH at the time of an environmental temperature change is excessive, bonding may be made at a position located near to the outer periphery as shown in FIG. 8(b).

In this way, the object side surface of the compound eye optical system LH and the top surface portion LF2 are bonded to each other at a position located on the inside than the outer periphery of the object side surface, whereby it becomes possible to reduce a possibility that the compound eye optical system LH obstructs expansion or contraction due to a temperature change.

According to deformation simulation due to a temperature change performed by the present inventor, as compared with the case where bonding was made at a position shown in FIG. 8(b), in the case where bonding was made at a position shown in FIG. 8(a), it turned out that an amount of deformation, that is, an amount of displacement of the compound eye optical system LH in the optical axis direction increases about 15%. Further, as shown in FIG. 8(c), in the case where the compound eye optical system LH and the lens frame LF were bonded to each other at a position located further near to the central portion, an amount of displacement of the compound eye optical system LH in the optical axis direction increases about 65%.

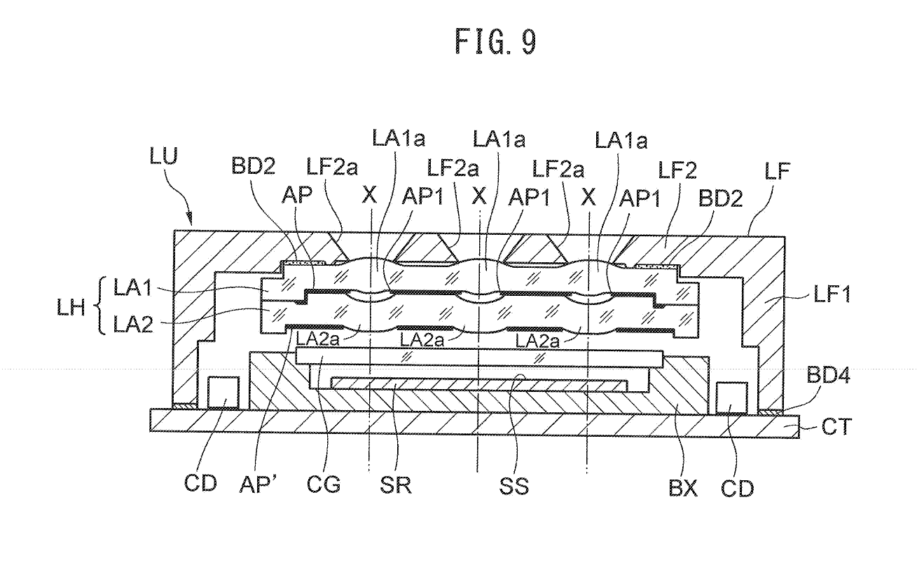

FIG. 9 is an illustration showing a modified example of the present embodiment. In the embodiment shown in FIG. 9, the size of the top surface portion LF2 of the lens frame LF in the direction perpendicular to the optical axis is further expanded such that the top surface portion LF2 covers circuit components CDs, such as a capacitor and a resistor, disposed on the substrate CT. With this, an amount of deformation of the top surface portion LF2 at the time of a temperature change is made to further increase, whereby an amount of displacement of the compound eye optical system LH in the optical axis direction can be secured. Further, in the case where an imaging device has a substrate CT, even if the lens frame LF is expanded to the substrate CT, a footprint size is not expanded. Accordingly, there are few possibilities that an imaging device is made to become a large size.

Incidentally, in any one of the above-mentioned embodiments, the first array lens LA1 and the second array lens LA2 are bonded to each other with the first bonding agent BD across (via) the metal light shielding member AP disposed between them. Here, in the case where one of the first array lens LA1 and the second array lens LA2 is not bonded to the light shielding member AP, when the top surface portion LF2 of the lens frame LF deforms as shown in in FIG. 7(b), there is a possibility that only the first array lens LA1 deflects in connection with the deformation and the optical axis of the lens LA1a is made to tilt. In contrast, in the case where the first array lens LA1, the second array lens LA2, and the light shielding member AP disposed between them are bonded firmly to each other, the rigidity of the compound eye optical system LH can be enhanced and the optical axis of lens LA1a can be prevented from tilting.

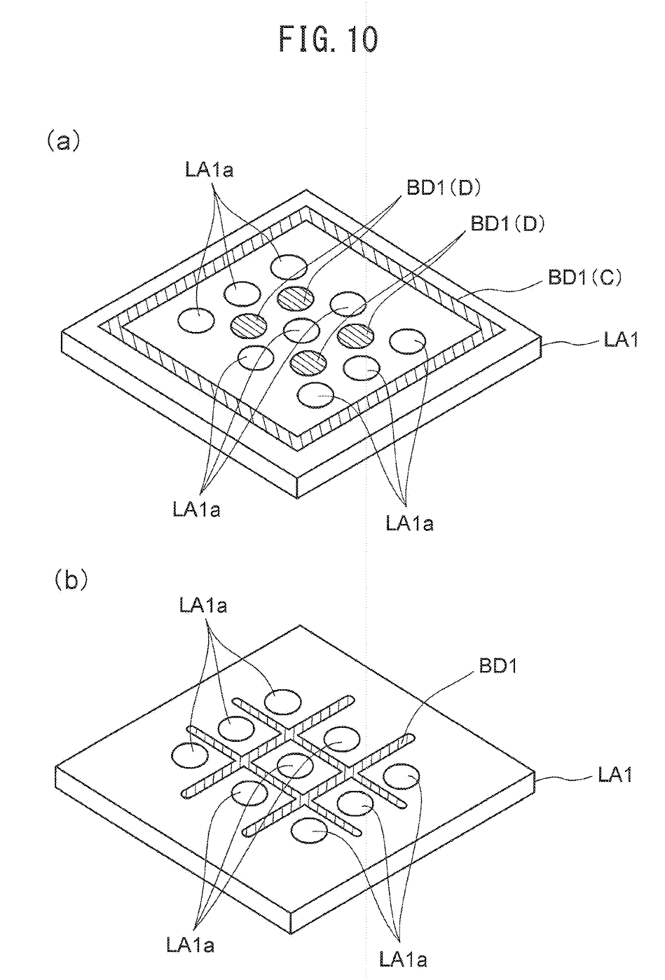

In such a case, when the first bonding agent BD1 is coated on the image side surface of the first array lens LA1 in order to bond firmly the first array lens LA1 to the second array lens LA2, as shown in FIG. 10(a), it is preferable to provide the first bonding agent BD1 to peripheries (D) of the central lens LA1a in addition to providing the first bonding agent BD1 to a region (C) located near to the outer periphery of the lens LA1a. Alternatively, as shown in FIG. 10(b), it is preferable to coat the first bonding agent BD1 in the form of a lattice so as to separate each of the lenses LA1a from the others.

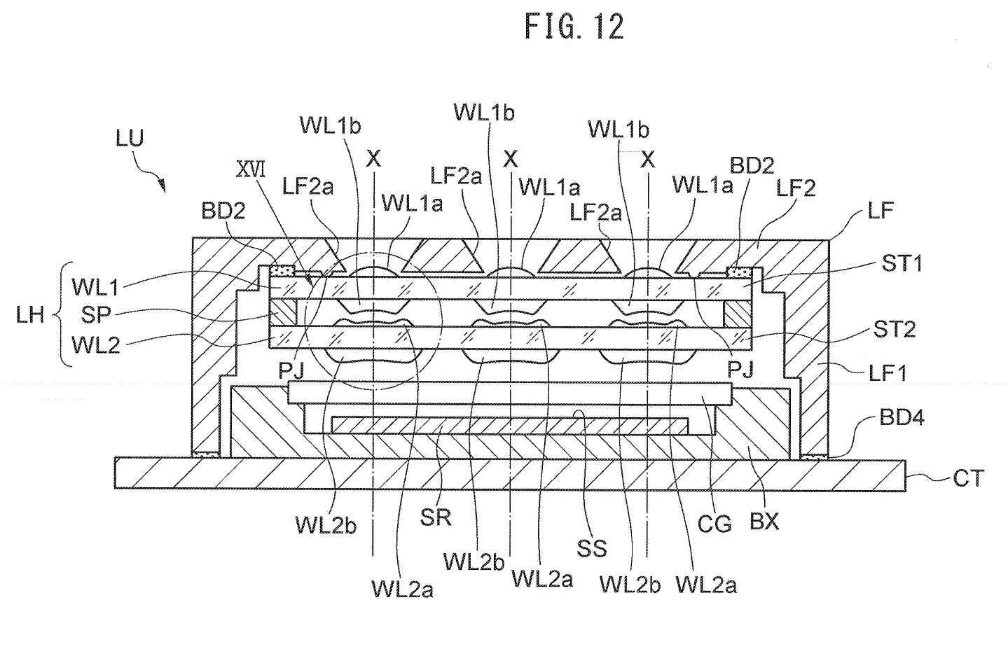

FIG. 12 is a cross sectional view similar to FIG. 2 and shows an imaging unit according to another embodiment. In the present embodiment, as the compound eye optical system LH, a so-called wafer lens is used by being stacked. In concrete terms, a first array lens WL1 being a wafer lens includes a first substrate ST1 made of glass, multiple first object side lenses WL1a made of resin and formed on the object side of the first substrate ST1, and multiple first image side lenses WL1b made of resin and formed on the image side of the first substrate ST1. Further, a second array lens WL2 being a wafer lens includes a second substrate ST2 made of glass, multiple second object side lenses WL2a made of resin and formed on the object side of the second substrate ST2, and multiple second image side lenses WL2b made of resin and formed on the image side of the second substrate ST2. On the surface of each of the substrate ST1 and ST2 except the lens portions, a black coating film (not-shown) which suppresses stray light is formed.

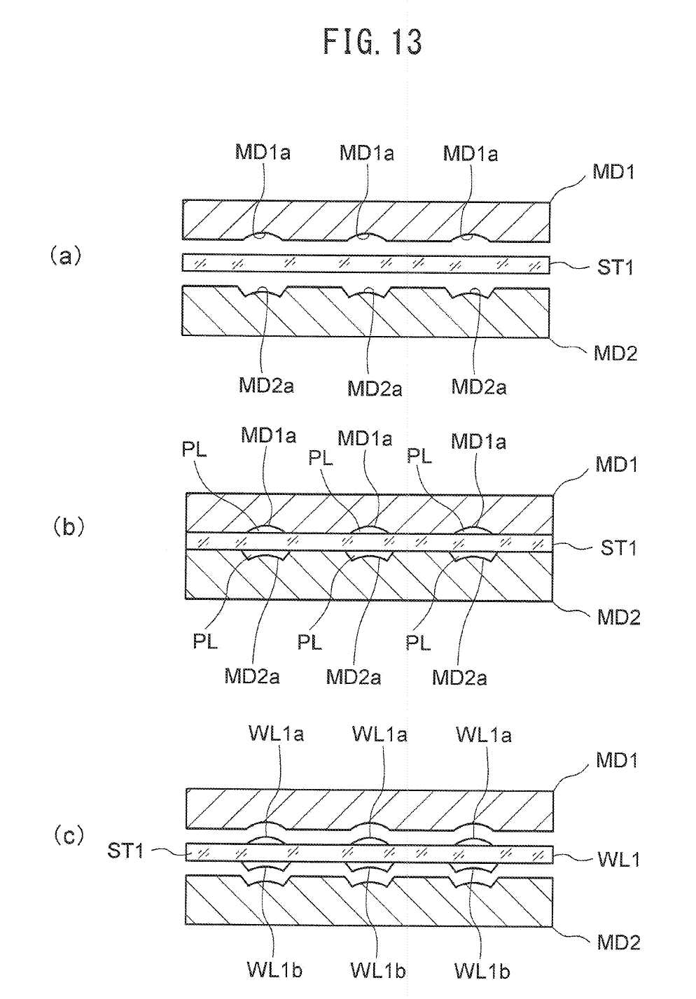

FIG. 13 is an illustration showing processes of molding the first array lens WL1. A first molding die MD1 and a second molding die MD2 have multiple optical surface transferring surfaces MD1a and MD2a respectively on respective surfaces which face each other. As shown in FIG. 13(a), the optical surface transferring surfaces MD1a and MD2a are arranged so as to face each other across the first substrate ST1 being a glass parallel flat plate disposed between the optical surface transferring surface MD1a and MD2a. Successively, as shown in FIG. 13(b), a resin material PL is filled up in each of the optical surface transferring surfaces MD1a and MD2a, and then the first molding die MD1 and the second molding die MD2 are clamped such that the underside surface of the first molding die MD1 and the top surface of the second molding die MD2 are brought respectively in close contact with the first substrate ST1. Subsequently, heat or UV light is irradiated from the outside of the molding dies so as to harden the resin material PL.

After hardening the resin material PL, as shown in FIG. 13(c), the first molding die MD1 and the second molding die MD2 are separated from each other so as to open the molding dies, whereby the first object side array lenses WL1a are formed on the object side surface of the first substrate ST1 by the optical surface transferring surfaces MD1a and the first image side array lenses WL1b are formed on the image side surface of the first substrate ST1 by the optical surface transferring surfaces MD2a. As a result, the first array lenses WL1 integrated into a single body can be molded. Through the same processes, the second array lenses WL2 can be molded. Since the substrate is made from a glass with little deformation for a temperature change, deterioration of the optical properties at the time of a temperature change can be suppressed.

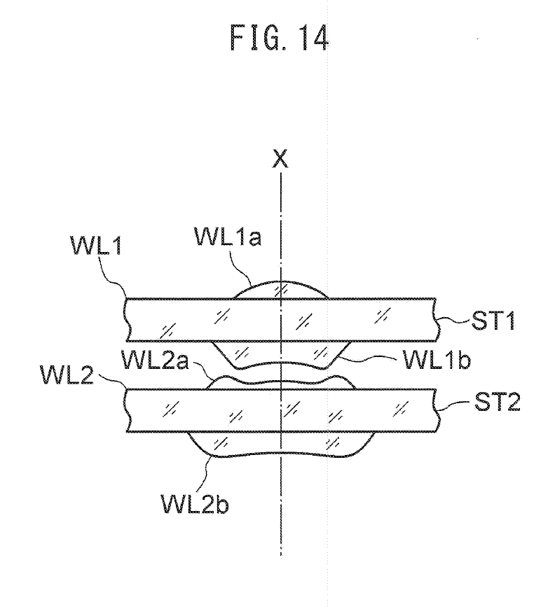

FIG. 14 is an illustration showing a portion indicted with an arrow head XVI in the array lenses WL1 and WL2 shown in FIG. 12 by expanding the portion. Each of the first object side lens WL1a and the first image side lens WL1b of the array lens WL1 and each of the second object side lens WL2a and the second image side lens WL2b of the array lens WL2 is formed with good precision by molding with the respective dies. Accordingly, by positioning the array lenses WL1 and WL2 precisely with alignment marks (not-shown), the respective optical axes of the lenses are made to coincide with each other.

In FIG. 12, in a portion between the first substrate ST1 and the second substrate ST2, spacers SP shaped in a frame or a block are disposed and bonded to the respective peripheral edges of the both substrates, whereby a distance between the both substrates is maintained at a predetermined value.

Similarly to the above-mentioned embodiments, in a portion between the side surface portion LF1 of the lens frame LF and the outer peripheral surface of the compound eye optical system LH, a gap is formed. Such a gap is made in a value with which the lens frame LF and the compound eye optical system LH are made not to come in contact with each other even when a temperature change arises from a room temperature to the highest temperature. Here, it is preferable that a gap between the first array lens LA1 and the lens frame LF is smaller than a gap between the second array lens LA2 and the lens frame LF

On a portion between the vicinity of a corner (refer to FIG. 3) of the object side surface of the first array lens WL1 of the compound eye optical system LH and the image side surface of the top surface portion LF2 of the lens frame LF, a second bonding agent BD2 is coated, whereby the compound eye optical system LH and the lens frame LF are bonded locally to each other. Here, on the outside of an opening LF2a on the underside surface of the top surface portion LF2, a protrusion PJ is formed so as to come in point or line contact with the top surface of the compound eye optical system LH. The second bonding agent (main bonding agent) BD2 may be a UV hardenable bonding agent. However, it is preferable that the second bonding agent BD2 is a heat hardenable bonding agent with a Young's modulus, after hardening, of 10 MPa or more and 500 MPa or less and a heat hardenable bonding agent capable of hardening at a temperature of 60° C. or less. In the present embodiment, a bonding agent is not provided between the side surface portion LF1 of the lens frame LF and the outer peripheral surface of the compound eye optical system LH. The constitutions other than the above are the same as those in the above-mentioned embodiment. Here, array lenses on one side of them may be made to array lenses (LA1, LA2) integrally made of resin by molding.

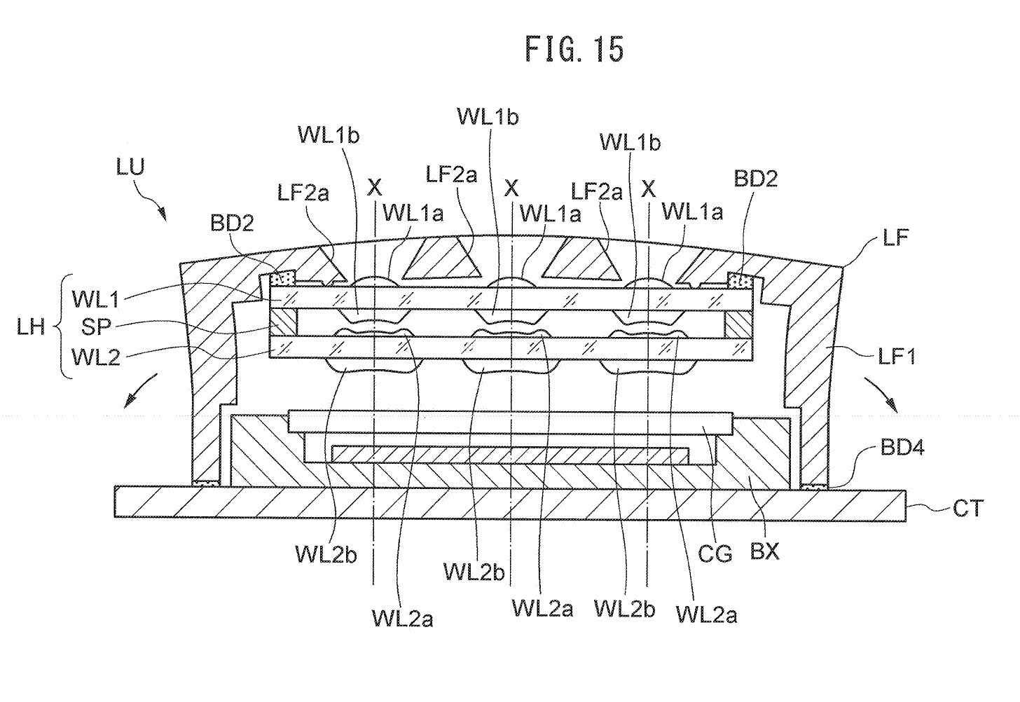

FIG. 15 is a cross sectional view similar to FIG. 12 and exaggeratedly shows deformation of the imaging device when a temperature change arises, in relation to the present embodiment. For example, when environmental temperature rises, in lenses WL1a, WL1b, WL2a, and WL2b of the compound eye optical system LH which are made of plastic, in the case of a convex lens, an image forming position generally goes far due to occurrence of a refractive index change by a temperature rise. In the case of a concave lens, a change of the image forming position is reverse to the above. However, since the total power of the respective optical systems is positive, the image forming position is made to go far in the total view. On the other hand, if the lens frame LF is subjected to the same temperature rise, the top surface portion LF2 deforms so as to become a convex form toward the upper portion (object side). Accordingly, its undersurface is raised upward. Here, since a part of the object side surface of the compound eye optical system LH is bonded to the undersurface of the top surface portion LF2, the compound eye optical system LH comparatively greatly moves to the side made to separate from the imaging sensor SR along the optical axis in response to the deformation of the lens frame LF. Accordingly, the change of the image forming position due to the refractive index change of the lenses WL1a, WL1b, WL2a, and WL2b can be reduced by the movement. In particular, in the case of the present embodiment, since each of the substrates ST1 and ST2 is made from a glass, the portions made from the glass are not likely to receive the influence of a temperature change. Accordingly, there is a merit that a warp is not likely to take place on the compound eye optical system LH. In concrete terms, at the time of a temperature change, since a warp is not likely to take place on the substrates ST1 and ST2, variation in lens back among the respective lenses can be made small. With this, an in-focus image can be acquired irrespective of a temperature change. When a temperature lowers, the movements are reverse to the above. That is, the image forming position of the lenses is made to come near, and the lens frame LF contracts, whereby a change of the image forming position can be reduced. Further, in the case where the Young's modulus of the second bonding agent BD2 is 10 MPa or more and 500 MPa or less, it is effective for shock resistance.

Next, description is given to specific examples of an ommatidium optical system.

Fno: F number
•: Half field angle)(°
r: Radius of curvature (mm)
d: Axial face spacing (mm)
nd: Refraction index of a lens material for d line
•d: Abbe's number of a lens material

In each example, S represents a surface number, and a surface where aspheric surface coefficients are described is a surface with an aspheric surface shape. The aspheric surface shape is represented by “Numeral 1” described below in which the apex of the surface is made to an origin, an X-axis is taken along an optical axis direction, and a height in a direction vertical to the optical axis is set to “h”.

Numeral 1

$$X = \frac{{h}^{2} / R}{1 + \sqrt{1 - ( 1 + K ) {h}^{2} / {R}^{2 }}} + \sum {A}_{i} {h}^{i}$$

Ai: i-th order aspheric surface coefficient
R: Radius of curvature
K: Conic constant

### Example 1

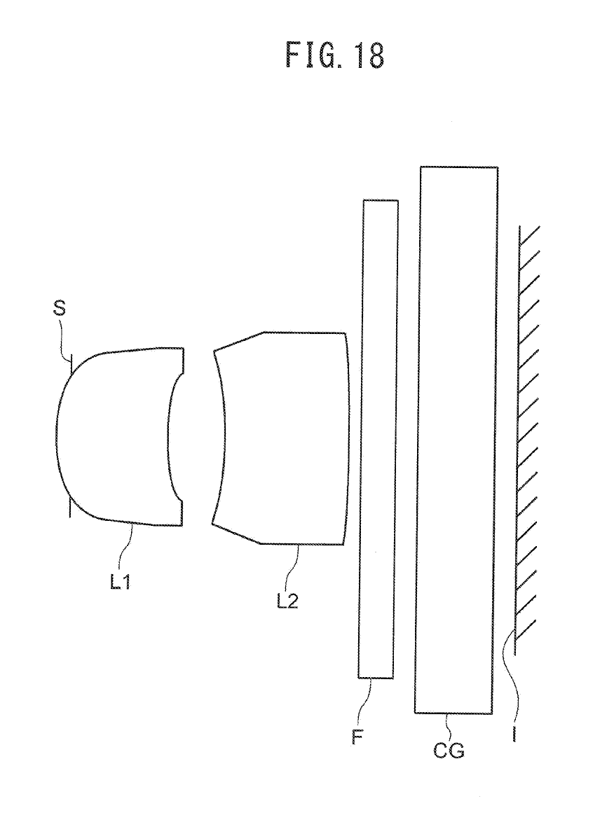

Example 1 is an example of an ommatidium optical system of a type where two lenses are stacked in an optical axis direction, and the lens data of Example 1 are shown in Table 2. FIG. 18 is a cross sectional view of the ommatidium optical system of Example 1. Example 1 corresponds to the above-mentioned embodiment, and the ommatidium optical system of Example 1 includes, in the order from the object side, an aperture stop S, a first lens L1, and a second lens L2. A symbol I represents an imaging surface, F represents a parallel plate supposed as an optical low pass filter or an infrared ray cut filter, and CG represents a parallel plate supposed as a cover glass to protect an imaging sensor. As a plastic material used for each lens, Appel 5514 (product name) manufactured by Mitsui Chemicals, Inc. was used. Hereafter (including lens data in Tables), a power of 10 (for example, 2.5×10⁻⁰²) is represented by using “E” (for example, 2.5E−02).

TABLE 2
Example 1
Unit: mm
[Table 2a] Optical system data

| s | r | d | nd | •d | |
|---|---|---|---|---|---|
| 1 | infinity | −0.09 | | | Stop |
| 2 | 0.6246 | 0.57 | 1.5447 | 56.20 | |
| 3 | 1.1431 | 0.30 | | | |
| 4 | −4.9482 | 0.63 | 1.5447 | 56.20 | |
| 5 | infinity | 0.07 | | | |
| 6 | infinity | 0.18 | 1.5231 | 54.5 | |
| 7 | infinity | 0.10 | | | |
| 8 | infinity | 0.40 | 1.5231 | 62.20 | |
| 9 | infinity | 0.11 | | | |
| 10 | infinity | 0.00 | | | image surface |

[Table 2b] Specific values

| | |
|---|---|
| Focal length | 2.02 |
| Fno | 3.1 |
| •(°) | 27.6 |
| Lens total length | 2.35 |

[Table 2c] Aspherical coefficient Ai and conic
constant K of an aspherical lens

| s | /2 | /3 | /4 | /5 |
|---|---|---|---|---|
| K | /−2.2276E+00 | /2.2157E+00 | /0.0000E+00 | /0.0000E+00 |
| A3 | /1.5247E−01 | /5.0669E−01 | /−1.0764E−01 | /0.0000E+00 |
| A4 | /1.8162E−01 | /−3.5626E+00 | /−6.1228E−01 | /−1.4880E−01 |
| A5 | /−7.3169E+00 | /0.0000E+00 | /0.0000E+00 | /0.0000E+00 |
| A6 | /8.2956E+01 | /1.1034E+02 | /1.0049E+00 | /−1.0830E+00 |
| A8 | /−1.4945E+03 | /−2.4613E+03 | /−1.0531E+02 | /4.4651E+00 |
| A10 | /1.7928E+04 | /3.6272E+04 | /1.2073E+03 | /−1.5922E+01 |
| A12 | /−1.1185E+05 | /−3.1555E+05 | /−6.1147E+03 | /3.4994E+01 |
| A14 | /2.7848E+05 | /1.4841E+06 | /9.5787E+03 | /−4.2273E+01 |
| A16 | /0.0000E+00 | /7.6503E+05 | /8.8057E+03 | /2.0762E+01 |

### Example 2

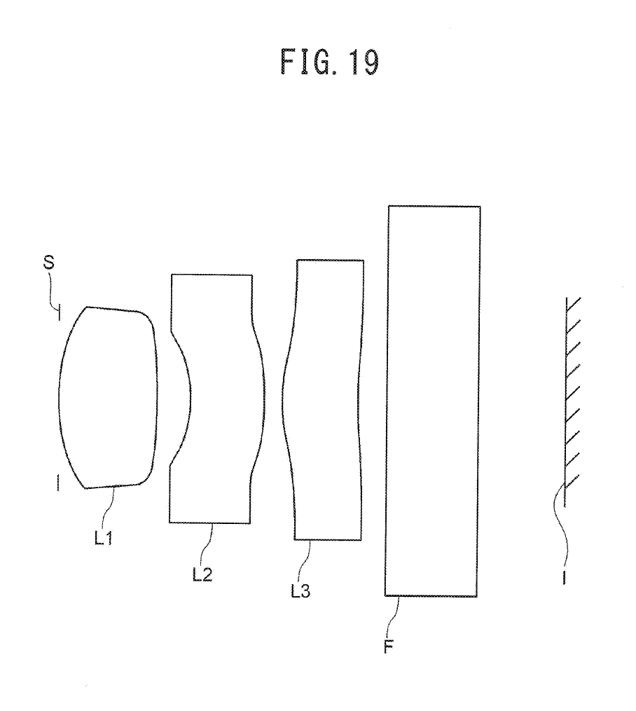

Example 2 is an example of an ommatidium optical system of a type where three lenses are stacked in an optical axis direction, and the lens data of Example 2 are shown in Table 3. FIG. 19 is a cross sectional view of the ommatidium optical system of Example 2. Example 2 corresponds to the above-mentioned embodiment, and the ommatidium optical system of Example 2 includes, in the order from the object side, an aperture stop S, a first lens L1, a second lens L2, and a third lens L3. A symbol I represents an imaging surface, and F represents a parallel plate supposed as an optical low pass filter or an infrared ray cut filter. As a plastic material used for each lens, Appel 5514 (product name) manufactured by Mitsui Chemicals, Inc. was used.

TABLE 3
Example 2
Unit: mm
[Table 3a] Optical system data

| s | r | d | nd | •d | |
|---|---|---|---|---|---|
| 1 | infinity | 0.00 | | | stop |
| 2 | 0.9259 | 0.55 | 1.5447 | 56.20 | |
| 3 | −2.6102 | 0.19 | | | |
| 4 | −0.5143 | 0.40 | 1.6347 | 23.87 | |
| 5 | −1.1149 | 0.10 | | | |
| 6 | 1.0100 | 0.41 | 1.5447 | 56.20 | |
| 7 | 1.3034 | 0.16 | | | |
| 8 | infinity | 0.51 | 1.5073 | 48.44 | |
| 9 | infinity | 0.48 | | | |
| | infinity | 0.00 | | | image surface |

[Table 3b] Specific values

| | |
|---|---|
| Focal length | 2.09 |
| Fno | 2.4 |
| •(°) | 25 |
| Lens total length | 2.8 |

[Table 3c] Aspherical coefficient Ai and conic
constant K of an aspherical lens

| s | /2 | /3 | /4 | /5 | /6 | /7 |
|---|---|---|---|---|---|---|
| K | /−2.8705E+00 | /−1.9906E+01 | /−3.9118E+00 | /−2.0000E+01 | /−9.4409E−01 | /1.5054E+00 |
| A4 | /4.9349E−01 | /1.0582E−01 | /−8.6343E−01 | /−1.1737E+00 | /−1.5129E+00 | /−7.7530E−01 |
| A6 | /−1.6215E+00 | /−2.6999E+00 | /1.0669E+01 | /8.5831E+00 | /4.7204E+00 | /−1.4220E+00 |
| A8 | /1.9007E+01 | /2.1966E+01 | /−9.2685E+01 | /−3.5086E+01 | /−3.3841E+01 | /2.8814E+00 |
| A10 | /4.8199E+01 | /−3.8753E+02 | /−2.1021E+01 | /7.2676E+01 | /1.4583E+02 | /5.3426E+01 |
| A12 | /−4.1323E+03 | /3.3290E+03 | /6.3859E+03 | /1.5536E+02 | /−2.3756E+02 | /−3.0904E+02 |
| A14 | /4.6724E+04 | /8.8606E+03 | /−3.7614E+04 | /−4.9071E+02 | /−3.4761E+02 | /2.6876E+02 |
| A16 | /−2.4549E+05 | /−3.4250E+05 | /8.5107E+02 | /−6.4159E+03 | /1.5615E+03 | /2.0711E+03 |
| A18 | /6.3341E+05 | /2.0601E+06 | /5.6963E+05 | /3.6736E+04 | /−6.7174E+02 | /−6.0389E+03 |
| A20 | /−6.4602E+05 | /−4.0137E+06 | /−1.2891E+06 | /−5.6530E+04 | /−1.4398E+03 | /4.8960E+03 |

### Example 3

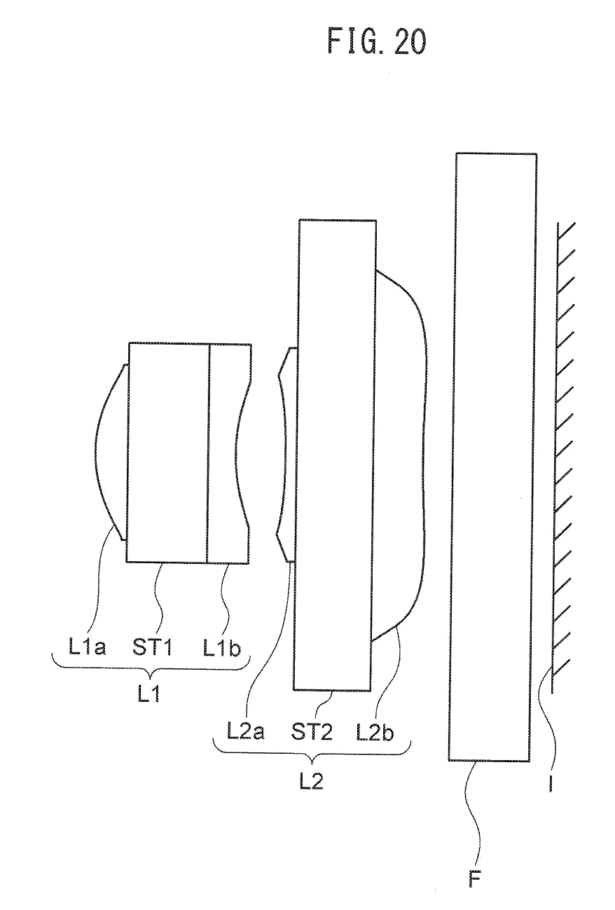

Example 3 is an example of an ommatidium optical system of a type where two lenses are stacked in an optical axis direction, and the lens data of Example 3 are shown in Table 4. FIG. 20 is a cross sectional view of the ommatidium optical system of Example 3. Example 3 corresponds to the above-mentioned embodiment, and the ommatidium optical system of Example 3 includes, in the order from the object side, a first lens L1, and a second lens L2. A symbol I represents an imaging surface, and F represents a parallel plate supposed as an optical low pass filter or an infrared ray cut filter. The first lens L1 is constituted such that a lens portion L1a is formed on an object side on a glass substrate ST1 and a lens portion L1b is formed on an image side on the glass substrate ST1. The second lens L2 is constituted such that a lens portion L2a is formed on an object side on a glass substrate ST2 and a lens portion L2b is formed on an image side on the glass substrate ST2. Each of the lens portions is made from a plastic material with optical properties described below.

TABLE 4
Example 3
Unit: mm
[Table 3a] Optical system data

| s | r | d | nd | •d | |
|---|---|---|---|---|---|
| 1 | 0.6453 | 0.18 | 1.5178 | 56.11 | |
| 2 | infinity | 0.41 | 1.5099 | 62.40 | stop |
| 3 | infinity | 0.14 | 1.5721 | 34.89 | |
| 4 | 1.5998 | 0.24 | | | |
| 5 | −6.6247 | 0.05 | 1.5721 | 34.89 | |
| 6 | infinity | 0.40 | 1.5099 | 62.40 | |
| 7 | infinity | 0.24 | 1.5721 | 34.89 | |
| 8 | 4.1492 | 0.16 | | | |
| 9 | infinity | 0.40 | 1.51 | 62.40 | |
| | | 0.00 | | | image surface |

[Table 4b] Specific values

| | |
|---|---|
| Focal length | 1.96 |
| Fno | 3.1 |
| •(°) | 28.2 |
| Lens total length | 2.32 |

[Table 4c] Aspherical coefficient Ai and conic
constant K of an aspherical lens

| s | /1 | /4 | /5 | /8 |
|---|---|---|---|---|
| K | /1.1069E+00 | /1.0979E+01 | /−5.0000E+01 | /1.7009E+01 |
| A3 | /−5.9413E−01 | /6.1769E−01 | /8.3911E−01 | /0.0000E+00 |
| A4 | /7.0995E+00 | /−4.7897E+00 | /−7.0111E+00 | /−1.6696E−01 |
| A5 | /−4.1475E+01 | /1.3427E+01 | /2.0085E+01 | /0.0000E+00 |
| A6 | /8.0744E+01 | /1.8056E−01 | /−2.7450E+01 | /−1.0526E+00 |
| A8 | /−2.1017E+01 | /−1.7599E+02 | /2.1736E+00 | /3.5261E+00 |
| A10 | /−1.6609E+03 | /9.6376E+02 | /1.1862E+02 | /−8.0428E+00 |
| A12 | /3.0325E+03 | /−5.2781E+02 | /5.1239E+02 | /1.0424E+01 |
| A14 | /5.7951E+04 | /−5.7440E+03 | /−7.0784E+03 | /−7.4196E+00 |
| A16 | /−2.5347E+05 | /0.0000E+00 | /1.7576E+04 | /2.1152E+00 |

Table 5 shows the focal length fl (mm) of a lens located on the most object side, the focal length f (mm) of the whole system, and the value of fl/f with regard to Examples 1 to 3. Further, Table 6 shows an amount of a change in back focus position in each of Examples 1 to 3 when temperature rose from +20° C. to +50° C.

TABLE 5

| | f1 | f | f1/f |
|---|---|---|---|
| EXAMPLE 1 | 1.81 | 2.02 | 0.90 |
| EXAMPLE 2 | 1.33 | 2.09 | 0.64 |
| EXAMPLE 3 | 1.71 | 1.96 | 0.87 |

TABLE 6

| | AN AMOUNT OF |
|---|---|
| | A CHANGE IN BACK WHEN 20 → 50° C. |
| EXAMPLE 1 | +14.9 μm |
| EXAMPLE 2 | +18 μm |
| EXAMPLE 3 | +14 μm |

Description is given to simulation results performed by the present inventor with regard to a compound eye optical system in which the ommatidium optical systems of Example 1 with the above-mentioned optical system data were arranged in the form of four rows and four columns. Here, the ommatidium optical system had a focal length of f=2.02 mm, and the compound eye optical system had a size of 11.5 mm×11.5 mm. As a plastic material used for each lens, Appel 5514 (product name) manufactured by Mitsui Chemicals, Inc. was used. On the other hand, the lens frame had a size of 14 (A) mm×14 (A) mm×2.8 (H) mm. The material of the lens frame was polycarbonate and its thickness was made to 5.5 mm in average. The lens frame and the compound eye optical system were bonded to each other at the position shown in FIG. 8(b), and as the bonding agent, 1539 (product name) manufactured by Three Bond Co., Ltd. Was used. Further, the first array lens and the second array lens were bonded on the outer periphery side, and furthermore, as shown in FIG. 7, the lens frame was bonded to the substrate on which the imaging sensor was disposed.

According to the results of this simulation, when a temperature change of +30° C. arose, in the compound eye optical system of Example 1, an image forming position changed by about 15 •m relative to an imaging surface due to the refractive index change of the plastic lenses. However, it turned out that a change of the image forming position relative to the imaging surface was able to be suppressed to about ±3.5 •m by the deformation of the lens frame. Further, it turned out that although an amount of correction for a change of the image forming position differs depending on the position of an ommatidium optical system, a width of variation was able to be suppressed to about 7 •m.

Hereinafter, preferable aspects in the present embodiment are described collectively.

It is preferable that a part of the first surface except the lenses of the compound eye optical system is bonded to the top surface portion of the lens frame in such a way that the movement of the image forming position which changes in accordance with a temperature change of the compound eye optical system is cancelled by the displacement of the lens frame which deforms in accordance with the above temperature change.

It is preferable that an outer peripheral side of the lenses of the compound eye optical system which is a portion other than the lenses of the first surface is bonded to the top surface portion of the lens frame.

It is preferable that a portion between the lenses of the compound eye optical system which is a portion other than the lenses of the first surface is bonded to the top surface portion of the lens frame.

It is preferable to satisfy the following condition.

2·A/H·10 (1)

A: Size of one side of the top surface portion of the lens frame (mm)
H: Height of the lens frame (mm)

It is preferable that the first surface of the compound eye optical system and the top surface portion of the lens frame are bonded to each other at a position on the inside than the outer periphery of the first surface.

It is preferable that a part of the first surface except the lenses of the compound eye optical system and the top surface portion of the lens frame are bonded with a bonding agent with a Young's modulus, after hardening, of 10 MPa or more and 500 MPa or less.

It is preferable that the bonding agent is a heat hardenable bonding agent capable of hardening at a temperature of 60° C. or less.

It is preferable that a solid state imaging sensor is fixed to a substrate and the side surface portion of the lens frame is bonded to the substrate.

It is preferable that circuit components for the solid state imaging sensor are disposed on an inner side of the side surface portion of the lens frame on the substrate.

It is preferable that a gap is formed between the compound eye optical system and the side surface portion of the lens frame.

It is preferable that the compound eye optical system is constituted such that multiple array lenses are stacked in an optical axis direction.

It is preferable that the multiple array lenses are fixed to each other with a bonding agent provided at a portion between the lenses which neighbor on each other in a direction perpendicular to the optical axis.

It is preferable that on a portion between the multiple array lenses, a light shielding member to shade between the lenses is disposed, and a bonding agent is provided between the array lenses and the light shielding member.

It is preferable that two array lenses of the multiple array lenses are bonded to each other on a condition that the light shielding member is disposed between the two array lenses.

It is preferable that, in terms of a thickness of the side surface portion of the lens frame, a thickness on a far side from the top surface portion side is thinner than a thickness on a near side to the top surface portion side.

It is preferable that the array lens includes a substrate made from a glass, a plurality of first lens portions disposed on one side surface of the substrate, and a plurality of second lens portions disposed on another side surface of the substrate.

It is preferable that the array lens is made of plastic integrally into a single body.

It is clear for a person skilled in the art from the embodiments, the examples, and the technical concepts described in the present specification that the present invention should not be limited to the embodiments and the examples described in the present specification and includes another example and modified examples.

### INDUSTRIAL APPLICABILITY

The compound eye optical system according to the present invention can be used not only for a super-resolution type but also for an imaging device of a view field separation type.

### REFERENCE SIGNS LIST

1 Image processing unit
1a Image synthesizing section
1b Image correcting section
2 Arithmetic operation unit
3 Memory
AP Light shielding member
AP1 Opening
BD1 First bonding agent
BD2 Second bonding agent
BD3 Third bonding agent
BD4 Fourth bonding agent
BX Lower casing
CG Cover glass
DU Imaging device
LA1 First array lens
LA1a Object side lens
LA2 Second array lens
LA2a Image side lens
LF Lens frame
LF1 Side surface portion
LF2 Top surface portion
LF2a Opening
LH Compound eye optical system
LU Imaging unit
ML Ommatidium synthetic image
SR Imaging sensor
SS Imaging surface
WL1 First array lens
WL1a First object side lens
WL1b First image side lens
WL2 Second array lens
WL2a Second object side lens
WL2b Second image side lens
ST1 First substrate
ST2 Second substrate
X Optical axis
Zn Ommatidium image

1. An imaging device, comprising:
a compound eye optical system equipped with an array lens in which multiple lenses are arranged in a form of an array such that each of the multiple lenses has an optical axis different from those of the other lenses and at least a part of the multiple lenses is made of plastic;
a lens frame which is made of plastic and includes a top surface portion to cover a portion, except the lenses, of an object-side first surface of the compound eye optical system and a side surface portion to support the top surface portion; and
a solid state imaging sensor for converting an image of an object formed by the compound eye optical system into electric signals;
wherein the side surface portion of the lens frame is bonded to the solid state imaging sensor or to a member fixed to the solid state imaging sensor, and
a part, except the lenses, of the first surface of the compound eye optical system is bonded to the top surface portion of the lens frame.

2. The imaging device described in claim 1, wherein a part, except the lenses, of the first surface of the compound eye optical system is bonded to the top surface portion of the lens frame in such a way that movement of an image forming position which changes in accordance with a temperature change of the compound eye optical system is cancelled by displacement of the lens frame which deforms in accordance with the temperature change.

3. The imaging device described in claim 1, wherein an outer peripheral side of the lenses of the compound eye optical system which is a portion other than the lenses of the first surface is bonded to the top surface portion of the lens frame.

4. The imaging device described in claim 1, wherein a portion between the lenses of the compound eye optical system which is a portion other than the lenses of the first surface is bonded to the top surface portion of the lens frame.

5. The imaging device described in claim 1, wherein the following condition is satisfied.
2≦A/H≦10 (1)
A: Size of one side of the top surface portion of the lens frame (mm)
H: Height of the lens frame (mm)

6. The imaging device described in claim 1, wherein the first surface of the compound eye optical system and the top surface portion of the lens frame are bonded to each other at a position on an inside than an outer periphery of the first surface.

7. The imaging device described in claim 1, wherein a part, except the lenses, of the first surface of the compound eye optical system and the top surface portion of the lens frame are bonded with a bonding agent with a Young's modulus, after hardening, of 10 MPa or more and 500 MPa or less.

8. The imaging device described in claim 1, wherein the bonding agent is a heat hardenable bonding agent capable of hardening at a temperature of 60° C. or less.

9. The imaging device described in claim 1, wherein the solid state imaging sensor is fixed to a substrate and the side surface portion of the lens frame is bonded to the substrate.

10. The imaging device described in claim 9, wherein circuit components for the solid state imaging sensor are disposed on the substrate and on an inner side of the side surface portion of the lens frame.

11. The imaging device described in claim 1, wherein a gap is formed between the compound eye optical system and the side surface portion of the lens frame.

12. The imaging device described in claim 1, wherein the compound eye optical system is constituted such that multiple array lenses are stacked in an optical axis direction.

13. The imaging device described in claim 12, wherein the multiple array lenses are fixed to each other with a bonding agent provided at a portion between the lenses which neighbor on each other in a direction perpendicular to the optical axis.

14. The imaging device described in claim 12, wherein on a portion between the multiple array lenses, a light shielding member to shade between the lenses is disposed, and a bonding agent is provided on a portion between the array lenses and the light shielding member.

15. The imaging device described in claim 14, wherein two array lenses of the multiple array lenses are bonded to each other on a condition that the light shielding member is disposed between the two array lenses.

16. The imaging device described in claim 1, wherein the array lens includes a substrate made of a glass, a plurality of first lens portions disposed on one side of the substrate, and a plurality of second lens portions disposed on another side of the substrate.

17. The imaging device described in claim 1, wherein the array lens is made of plastic integrally into a single body.

18. A lens unit comprising:
a compound eye optical system equipped with an array lens in which multiple lenses are arranged in a form of an array such that each of the multiple lenses has an optical axis different from those of the other lenses and at least a part of the multiple lenses is made of plastic; and
a lens frame which is made of plastic and includes a top surface portion to cover a portion, except the lenses, of an object-side first surface of the compound eye optical system and a side surface portion to support the top surface portion;
wherein a part, except the lenses, of the first surface of the compound eye optical system is bonded to the top surface portion of the lens frame, and the side surface portion of the lens frame includes an end portion capable of being bonded to a solid state imaging sensor for converting an image of an object formed by the compound eye optical system into electric signals or to a member fixed to the solid state imaging sensor.

19. A method for manufacturing an imaging device which includes a compound eye optical system equipped with an array lens in which multiple lenses are arranged in a form of an array such that each of the multiple lenses has an optical axis different from those of the other lenses and at least a part of the multiple lenses is made of plastic and a lens frame which is made of plastic and includes a side surface portion to surround an outer periphery of the compound eye optical system and a top surface portion to cover a part, except the lenses, of a first surface of the compound eye optical system;
the method for manufacturing an imaging device comprising:
providing a bonding agent onto the top surface portion of the lens frame;
bonding and securing the compound eye optical system to the lens frame; and
bonding and securing the side surface portion of the lens frame to a solid state imaging sensor or to a member fixed to the solid state imaging sensor.

20. A method for manufacturing an imaging device which includes a compound eye optical system equipped with an array lens in which multiple lenses are arranged in a form of an array such that each of the multiple lenses has an optical axis different from those of the other lenses and at least a part of the multiple lenses is made of plastic and a lens frame which is made of plastic and includes a side surface portion to surround an outer periphery of the compound eye optical system and a top surface portion to cover a part, except the lenses, of a first surface of the compound eye optical system;
the method for manufacturing an imaging device comprising:
providing a bonding agent onto a part, except the lenses, of a first surface of the compound eye optical system;
bonding and securing the lens frame to the compound eye optical system; and
bonding and securing the side surface portion of the lens frame to a solid state imaging sensor or to a member fixed to the solid state imaging sensor.
